(19) United States
(12) Patent Application Publication
(10) Pub. No.: US 2006/0125395 A1
(43) Pub. Date: Jun. 15, 2006

(54) Plasma display panel

(76) Inventor: Kyoung-Doo Kang, Suwon-si (KR)

Correspondence Address: Robert E. Bushnell, Suite 300, 1522 K Street, N.W., Washington, DC, 20005-1202, US

(21) Appl. No.: 11/293,141

(22) Filed: Dec. 5, 2005

(30) Foreign Application Priority Data
Dec. 9, 2004 (KR) 10-2004-0103646

(51) Int. Cl. H01J 17/49

(52) U.S. Cl. 313/582

(57) ABSTRACT

A plasma display panel having a new structure comprises: a back substrate; a front substrate disposed so as to be separated from the back substrate; barrier ribs disposed between the front and back substrates for defining, together with the back substrate and the front substrate, a plurality of discharge cells corresponding to sub-pixels; first discharge electrodes surrounding the discharge cells; second discharge electrodes separated by a predetermined distance from the first discharge electrodes so as to surround the discharge cells, and extending so as to cross a direction in which the first discharge electrodes extend; phosphor layers disposed in the discharge cells; and a discharge gas disposed in the discharge cells. The sub-pixels form unit pixels, and the unit pixels adjacent to each other, at least in a direction, are separated by predetermined distances from each other.

### CLAIM OF PRIORITY

This application makes reference to, incorporates the same herein, and claims all benefits accruing under 35 U.S.C. §119 from an application for PLASMA DISPLAY PANEL earlier filled in the Korean Intellectual Property Office on 9 Dec. 2004 and there duly assigned Serial No. 10-2004-0103646.

### BACKGROUND OF THE INVENTION

1. Field of the Invention

The present invention relates to a plasma display panel having a new structure.

2. Description of the Related Art

The plasma display panel is capable of substituting for the conventional cathode ray tube (CRT), and is a display device for displaying images by injecting a discharge gas between two substrates on which a plurality of electrodes are formed, for applying a discharge voltage to the discharge gas to generate ultraviolet rays, and for exciting a phosphor material by means of the ultraviolet rays.

The plasma display panel includes a back substrate and a front substrate facing each other. A plurality of address electrodes are arranged on a front surface of the back substrate, and the address electrodes are embedded by a first dielectric layer. In addition, barrier ribs define discharge cells on a front surface of the first dielectric layer. A phosphor layer is applied to a predetermined thickness in the discharge cells defined by the barrier ribs. The front substrate is a transparent substrate capable of permeating visible light, is mainly formed of glass, and is coupled to the back substrate on which the barrier ribs are formed. Sustain electrode pairs crossing the address electrodes are formed on a back surface of the front substrate. One electrode of each sustain electrode pair is an X electrode, and the other is a Y electrode. The sustain electrode pairs are embedded by a second dielectric layer, and a protective layer is formed on a back surface of the second dielectric layer.

In the plasma display panel having the above structure, a discharge cell which will emit light is selected by an address discharge occurring between the address electrode and the Y electrode, and the selected discharge cell emits light by means of a sustain discharge occurring between the X and Y electrodes in the selected discharge cell. In more detail, the discharge gas in the discharge cell emits ultraviolet rays by means of the sustain discharge, and the ultraviolet rays excite the phosphor layer to emit visible light. There are many conditions for improving the luminous efficiency of the plasma display panel. For example, the volume of the space wherein the sustain discharge exciting the discharge gas occurs should be large, the surface area of the phosphor layer should be large, and elements interrupting the visible light emitted from the phosphor layer should be minimal.

However, in the plasma display panel having the above structure, since the sustain discharge occurs in the space between the X and Y electrodes adjacent to the protective layer, the volume of the space wherein the sustain discharge occurs is small. In addition, the surface area of the phosphor layer is not large enough. Moreover, since some of the visible light emitted from the phosphor layer is absorbed and/or reflected by the protective layer, the second dielectric layer and the sustain electrodes, the amount of visible light penetrating the front substrate is about 60% of the visible light originally emitted from the phosphor layer.

### SUMMARY OF THE INVENTION

The present invention provides a plasma display panel having an improved luminous efficiency, improved brightness, and reduced reactive power.

According to an aspect of the present invention, a plasma display panel comprises: a back substrate; a front substrate separated from the back substrate so as to define a plurality of sub-pixels between the front and back substrates; and first discharge electrodes and second discharge electrodes extending so as to cross each other and generating a discharge in the sub-pixels; wherein the sub-pixels form unit pixels, and the unit pixels adjacent to each other, at least in a direction, are separated by predetermined distances from each other.

According to another aspect of the present invention, a plasma display panel comprises: a back substrate; a front substrate disposed so as to be separated from the back substrate; barrier ribs disposed between the front and back substrates for defining, together with the front and back substrates, a plurality of discharge cells corresponding to sub-pixels; first discharge electrodes surrounding the discharge cells; second discharge electrodes separated by a predetermined distance from the first discharge electrodes so as to surround the discharge cells, and extending so as to cross the direction in which the first discharge electrodes extend; phosphor layers disposed in the discharge cells; and a discharge gas disposed in the discharge cells; wherein the sub-pixels form unit pixels, and the unit pixels adjacent to each other, at least in a direction, are separated by a predetermined distance from each other.

The first discharge electrodes may function as address electrodes, and the second discharge electrodes may function as scan electrodes. The unit pixels arranged in a direction where the first discharge electrodes extend may be separated by predetermined distances from each other.

The barrier ribs defining the two neighboring unit pixels may be separated by a predetermined distance from each other so that the separated portion between the unit pixels can form a non-discharge region.

The neighboring unit pixels maybe disposed so as to share at least one barrier rib, and a width of the barrier rib shared by the neighboring unit pixels is preferably larger than widths of the barrier ribs disposed in the unit pixels. The barrier ribs may include longitudinal barrier rib portions disposed in the direction in which the first discharge electrodes extend, and transverse barrier rib portions crossing the longitudinal barrier rib portions. Widths of the longitudinal barrier rib portions defining the unit pixel may be larger than those of the longitudinal barrier rib portions disposed in the unit pixel.

Each unit pixel may include four sub-pixels, and may include one red sub-pixel, one green sub-pixel, and two blue sub-pixels.

In the plasma display panel according to the present invention, since the unit pixels are separated from each other, reactive power can be reduced and luminous efficiency can be improved.

In the plasma display panel according to the present invention, a surface discharge can occur from every side surface forming the discharge space, and the discharge area can be greatly increased.

In the plasma display panel according to the present invention, since the discharge starts from the side surfaces forming the discharge cell and is diffused toward the center portion of the discharge cell, the discharge area can be increased greatly, and the entire discharge cell can be efficiently used. Therefore, the panel can be driven with low voltage, and thus, the luminous efficiency can be increased.

The plasma display panel according to the present invention can be driven with low voltage, and thus low voltage operation can be possible, even when high concentration Xe gas is used as the discharge gas, and the luminous efficiency can be improved.

In the plasma display panel according to the present invention, the discharge response speed is very fast, and low voltage operation can be performed. That is, since the discharge electrodes are not disposed on the front substrate through which the visible light is transmitted, but are disposed at the side surfaces of the discharge cell, there is no need to use a transparent electrode of high resistance as the discharge electrode. Instead of the transparent electrode, an electrode of low resistance (for example, a metal electrode) can be used as the discharge electrode, and thus the discharge response speed can increase and low voltage operation can be performed without distorting waveforms.

In the plasma display panel according to the present invention, a permanent residual image can be fundamentally prevented. That is, an electric field generated by the voltage applied to the discharge electrode formed at the side surface of the discharge space causes the plasma to concentrate at the center portion of the discharge space, and thus, collision of ions with the phosphor material due to the electric field can be prevented, even when the discharge occurs for a long period of time. Thus, the permanent residual image generated due to damage of phosphor material can be fundamentally prevented. In particular, the problem of permanent residual image is severe in the case wherein high concentration Xe gas is used as the discharge gas. However, the plasma display panel of the present invention can prevent the permanent residual image from being generated.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a plasma display panel;

FIG. 2 is an exploded perspective view of a plasma display panel according to a first embodiment of the present invention;

FIG. 3 is a cross-sectional view of the plasma display panel taken along line III-III of FIG. 2;

FIG. 4 is a schematic diagram of an arrangement of discharge cells and first and second discharge electrodes shown in FIG. 2;

FIG. 5 is a schematic diagram of an arrangement of the discharge cells, sub-pixels, and unit pixels taken along line V-V of FIG. 3;

FIG. 6 is a schematic diagram of the discharge cells, the sub-pixels, and the unit pixels taken along line VI-VI of FIG. 3;

FIG. 7 is a schematic diagram of a modified version of the plasma display panel according to the first embodiment of the present invention, corresponding to the arrangement of FIG. 5;

FIG. 8 is an exploded perspective view of a plasma display panel according to a second embodiment of the present invention;

FIG. 9 is a cross-sectional view of the plasma display panel taken along line IX-IX of FIG. 8; and

FIG. 10 is a schematic diagram of an arrangement of discharge cells, sub-pixels, and unit pixels taken along line X-X of FIG. 9.

### DETAILED DESCRIPTION OF THE INVENTION

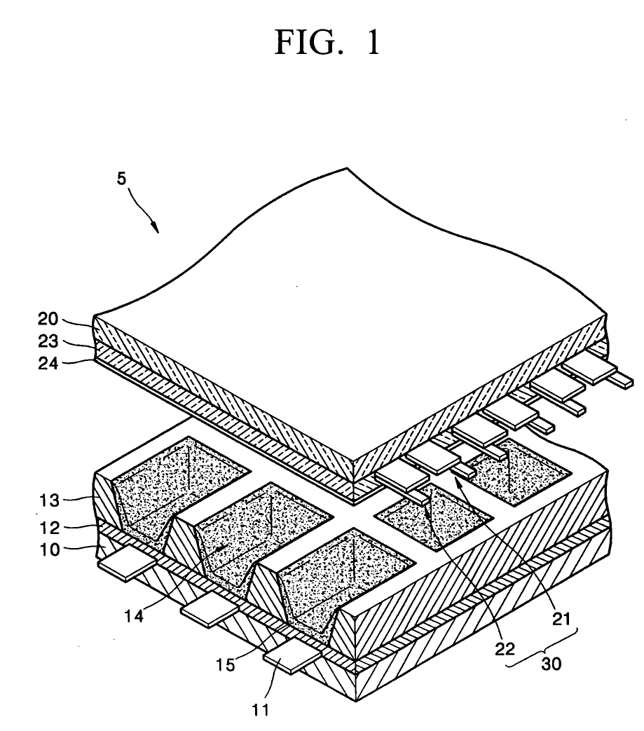

FIG. 1 is an exploded perspective view of a plasma display panel, and more specifically an alternating current (AC) three-electrode type surface discharge plasma display panel.

Referring to FIG. 1, the plasma display panel 5 includes a back substrate 10 and a front substrate 20 facing each other. A plurality of address electrodes 11 are arranged on a front surface of the back substrate 10, and the address electrodes 11 are embedded by a first dielectric layer 12. In addition, barrier ribs 13 define discharge cells 14 on a front surface of the first dielectric layer 12. A phosphor layer 15 is applied to a predetermined thickness in the discharge cells 14 defined by the barrier ribs 13. The front substrate 20 is a transparent substrate capable of permeating visible light, is mainly formed of glass, and is coupled to the back substrate 10, on which the barrier ribs 13 are formed. Sustain electrode pairs 30 crossing the address electrodes 11 are formed on a back surface of the front substrate 20. One of each sustain electrode pair is an X electrode 21, and the other is a Y electrode 22. The sustain electrode pairs 30 are embedded by a second dielectric layer 23, and a protective layer 24 is formed on a back surface of the second dielectric layer 23.

In the plasma display panel having the above structure, a discharge cell 14 which will emit light is selected by an address discharge occurring between the address electrode 11 and the Y electrode 22, and the selected discharge cell 14 emits light by means of a sustain discharge occurring between the X and Y electrodes 21 and 22, respectively, in the selected discharge cell. In more detail, the discharge gas in the discharge cell emits ultraviolet rays by means of the sustain discharge, and the ultraviolet rays excite the phosphor layer 15 to emit visible light. There are many conditions for improving the luminous efficiency of the plasma display panel 5. For example, the volume of the space wherein the sustain discharge exciting the discharge gas occurs should be large, the surface area of the phosphor layer 15 should be large, and elements interrupting the visible light emitted from the phosphor layer 15 should be minimal.

However, in the plasma display panel 5 having the above structure, since the sustain discharge occurs in the space between the X and Y electrodes 21 and 22, respectively, adjacent to the protective layer 24, the volume of the space wherein the sustain discharge occurs is small. In addition, the surface area of the phosphor layer 15 is not large enough. Moreover, since some of the visible light emitted from the phosphor layer 15 is absorbed and/or reflected by the protective layer 24, the second dielectric layer 23, and the sustain electrodes 21 and 22, the amount of visible light penetrating the front substrate 20 is about 60% of the visible light originally emitted from the phosphor layer 15.

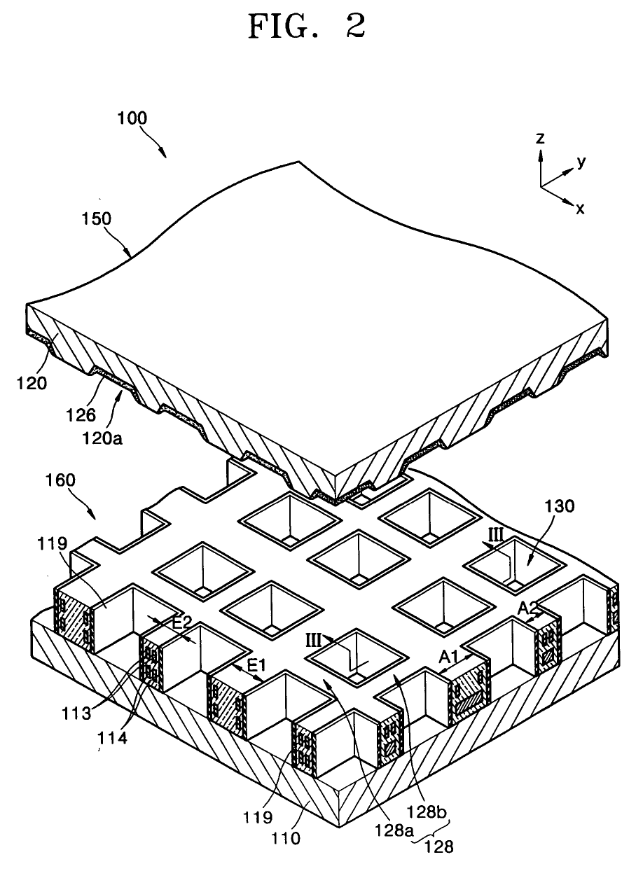

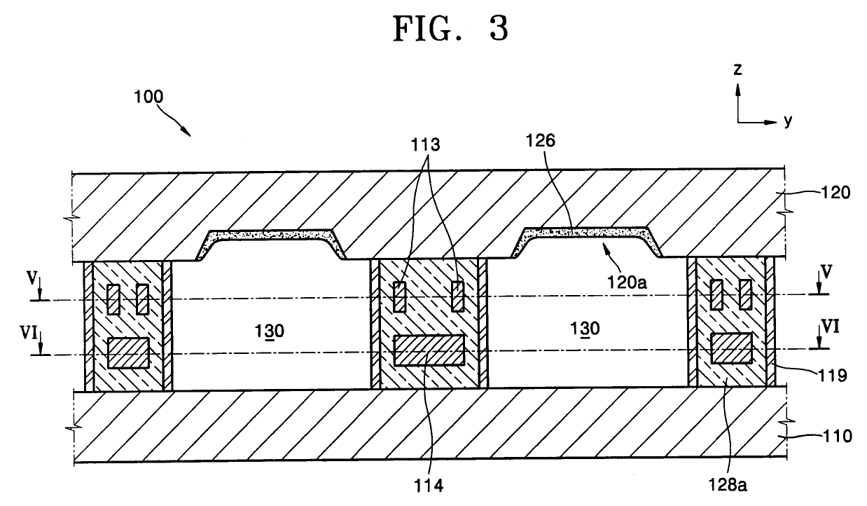

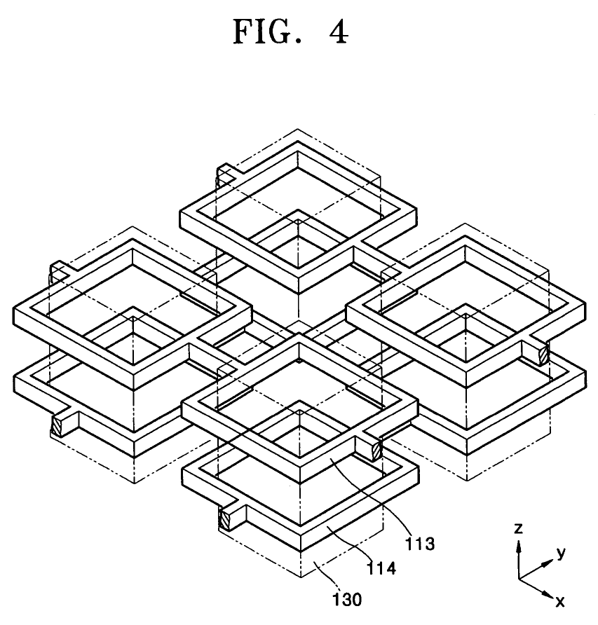

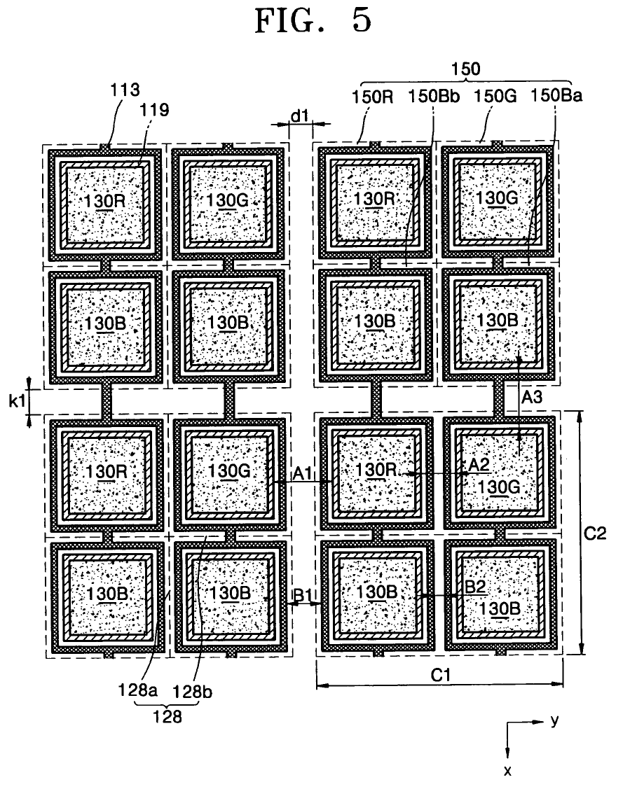

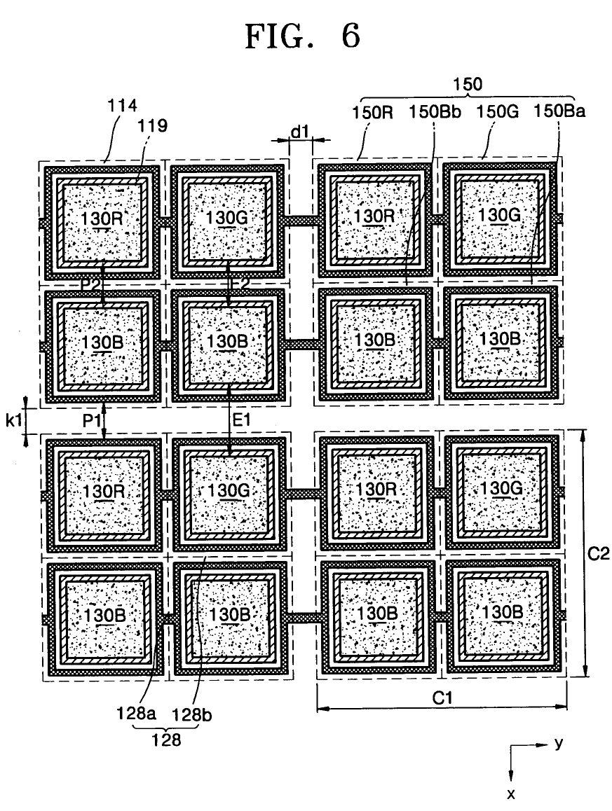

FIG. 2 is an exploded perspective view of a plasma display panel according to a first embodiment of the present invention; FIG. 3 is a cross-sectional view of the plasma display panel taken along line III-III of FIG. 2; FIG. 4 is a schematic diagram of an arrangement of discharge cells and first and second discharge electrodes shown in FIG. 2; FIG. 5 is a schematic diagram of an arrangement of the discharge cells, sub-pixels, and unit pixels taken along line V-V of FIG. 3; and FIG. 6 is a schematic diagram of the discharge cells, the sub-pixels, and the unit pixels taken along line VI-VI of FIG. 3

Referring to FIGS. 2 thru 6, the plasma display panel 100 includes a front substrate 120, a phosphor layer 126, barrier ribs 128, first discharge electrodes 113, second discharge electrodes 114, a protective layer 119, and a back substrate 110.

The back substrate 110 and the front substrate 120 are separated from each other, and barrier ribs 128 between the front substrate 120 and back substrate 110 partition a plurality of discharge cells 130. Each of the discharge cells 130 corresponds to one of red sub-pixel 150R, green sub-pixel 150G, and blue sub-pixel 150B (see FIG. 5), and a predetermined number of sub-pixels form a unit pixel 150. The pixels will be described in detail later.

The front substrate 120 (FIG. 2), through which the visible light generated by the discharge cells 130 can penetrate, is formed of a material having high light transmittance, such as glass. The back substrate 110 is also generally formed of glass.

Further referring to FIG. 2, the discharge cells 130 are arranged in a matrix form, and the barrier ribs 128 are formed so that transverse cross sections of the discharge cells 130 can be formed as square shapes. However, formation of the barrier ribs 128 is not limited thereto, and the barrier ribs 128 can be in various forms, such as waffle and delta forms, so long as they can define a plurality of discharge spaces. In addition, the transverse cross-section of each discharge cell 130 can be formed as a polygon, such as a triangle or a pentagon, a circle, or an oval shape, in addition to the square shape. In the present invention, it is desirable that the transverse cross section of each discharge cell 130 be formed as a regular square so that the unit pixel 150 can be formed as a regular square. The barrier ribs 128 include longitudinal barrier rib portions 128a disposed in a direction (x direction) in which first discharge electrodes 113 extend, and transverse barrier rib portions 128b crossing the longitudinal barrier rib portions 128a.

Referring to FIG. 4, first discharge electrodes 113 and second discharge electrodes 114 are disposed so as to surround the discharge cells 130. The first and second discharge electrodes 113 and 114, respectively, are formed as a plurality of square loops, and are disposed in the barrier ribs 128. The first discharge electrodes 113 extend so as to surround the discharge cells 130 arranged in a first direction (x direction). The second discharge electrodes 114 also extend so as to surround the discharge cells 130 which are arranged in a second direction (y direction) so as to cross the first discharge electrodes 113. In the barrier ribs 128, the first discharge electrodes 113 and the second discharge electrodes 114 are separated from each other.

To make the discharge uniform in the discharge cell 130, it is desirable that loop portions of the first and second discharge electrodes 113 and 114, respectively, be formed so as to be symmetric in the up-and-down direction.

In the plasma display panel 100 of FIG. 2 according to the present invention, a two-electrode type plasma display panel is used. Therefore, one of the first and second discharge electrodes 113 and 114, respectively, functions as a scan electrode, and the other functions as an address electrode. In the present embodiment, the first discharge electrode 113 functions as the address electrode, and the second discharge electrode 114 functions as the scan electrode.

Since the first and second discharge electrodes 113 and 114, respectively, are disposed in the barrier ribs 128, the electrodes 113 and 114 are not elements which lower the visible light transmittance toward the front direction (z direction). Therefore, the first and second discharge electrodes 113 and 114, respectively, can be formed of metal having high electric conductivity, such as aluminum or copper, instead of using indium tin oxide (ITO), and thus voltage dropping in a lengthwise direction can be reduced, and the signal can be transmitted stably.

It is desirable that the barrier ribs 128 be formed of dielectric material so that the barrier ribs 128 prevent the first and second discharge electrodes 113 and 114, respectively, from directly conducting with each other, and so that positive ions or electrons are prevented from directly colliding with the electrodes 113 and 114 so as to prevent the electrodes 113 and 114 from being damaged, and so that electric charges are induced so as to accumulate wall charge.

On a back surface of the front substrate 120 facing the discharge cells 130, grooves 120a are formed. The grooves 120a are discontinuously formed, and it is desirable that the grooves 120a be formed on positions corresponding to center portions of the discharge cells 130. However, the shapes of the grooves 120a are not limited thereto.

The grooves 120a are formed so as to have predetermined depths. Therefore, the thickness of the front substrate 120 can be reduced due to the grooves 120a, and thus, the visible light transmittance toward the front direction (z direction) can be increased.

Red, green, and blue phosphor layers 126 are applied to a predetermined thickness in the grooves 120a. However, the phosphor layers 126 can be applied at any portion in the discharge cells 130, and it is desirable that the phosphor layers 126 be disposed between the front substrate 120 and the electrodes 113 and 114 for forming the transmission structure plasma display panel.

The red discharge cell 130R (FIG. 5), on which the red phosphor layer is disposed, corresponds to a red sub-pixel 150R, the green discharge cell 130G, on which the green phosphor layer is disposed, corresponds to a green sub-pixel 150G, and the blue discharge cell 130B, on which the blue phosphor layer is disposed, corresponds to a blue sub-pixel 150B.

The phosphor layer 126 (FIG. 2) includes a component receiving ultraviolet rays so as to emit visible light. The red phosphor layer formed in the red discharge cell 130R (FIG. 5) includes a phosphor material such as Y(V,P)O₄:Eu, etc., the green phosphor layer formed in the green discharge cell 130G includes a phosphor material such as Zn₂SiO₄:Mn, etc., and the blue phosphor layer formed in the blue discharge cell 130B includes a phosphor material such as BAM:Eu, etc.

It is desirable that protective layers 119 (FIG. 2) be formed on side surfaces of the barrier ribs 128. The protective layers 119 prevent the barrier ribs 128, formed of the dielectric material, and the first and second discharge electrodes 113 and 114, respectively, from being damaged by the sputtering of plasma particles, and emit secondary electrons to lower the discharge voltage. The protective layers 119 can be formed by applying MgO on the sides of the barrier ribs 128 to predetermined thicknesses. The protective layers 119 are mainly formed as thin films in a sputtering, E-beam evaporation process.

A discharge gas, such as Ne, Xe, or a mixed gas thereof, is injected into the discharge cells 130. According to the present invention, discharge surfaces increase and the discharge region can be expanded, and the amount of generated plasma is increased. Thus, the plasma display panel 100 can be driven with low voltage. Therefore, even when Xe gas of high concentration is used as the discharge gas, the plasma display panel 100 can be driven with the low voltage, and thus, the luminous efficiency can be noticeably improved. Thus, the problem of prior arrangements, wherein low voltage driving cannot be performed in a case where the Xe gas of high concentration is used as the discharge gas, can be solved by the present invention.

Referring to FIGS. 5 and 6, arrangement of the unit pixels 150 in the plasma display panel 100 is shown. Each unit pixel 150 includes four sub-pixels 150R, 150G, 150Ba and 150Bb. In the present embodiment, the sub-pixel is a virtual region including portions of the first and second discharge electrodes 113 and 114, respectively, surrounding the discharge cell 130, and a predetermined portion of the barrier rib 128 embedding the electrodes 113 and 114. The unit pixel includes one red sub-pixel 150R, one green sub-pixel 150G, and two blue sub-pixels 150Ba and 150Bb. In general, the brightness of the blue light emitted by the blue discharge cell is low. Therefore, in order to compensate for the brightness of the blue light, the number of blue sub-pixels is relatively larger than any other sub-pixels in the unit pixel 150. In addition, the sub-pixels included in the unit pixel 150 are arranged in an order of 150R, 150G, 150Ba and 150Bb in a predetermined direction. However, the arrangement of the sub-pixels in the unit pixel 150 is not limited to the above arrangement. In addition, the number of red sub-pixels or green sub-pixels can be increased relatively more than that of the blue sub-pixels. Moreover, the unit pixel 150 can include a white sub-pixel as well as the red, green, and blue sub-pixels.

It is desirable that the unit pixel 150 be formed as a regular square, that is, that it have a transverse length C1 and a longitudinal length C2 which are the same as each other. Thus, the entire shape of the plasma display panel 100 can be formed freely. It is desirable that each sub-pixel have a regular square shape so that the unit pixel 150 has a regular square shape.

In addition, the unit pixels 150 disposed in the direction in which the second discharge electrodes 114 extend (that is, in the y direction) are separated from each other with predetermined distances (d1) therebetween. The structure between the unit pixels 150 can be variously defined, and in the present embodiment, a width (A1) of the longitudinal barrier rib portions defining the unit pixel 150 is larger than a width (A2) of the longitudinal barrier rib portions disposed in the unit pixel 150.

In addition, the unit pixels 150 arranged in the direction in which the first discharge electrodes 113 extend (that is, in the x direction) are separated from each other with predetermined distances (k1) therebetween. The structure between the unit pixels 150 can be variously defined. In the present embodiment, a width (E1) of the transverse barrier rib portions defining the unit pixel 150 is larger than a width (E2) of the transverse barrier rib portions disposed in the unit pixel 150.

In prior plasma display panels, there is no distance between the unit pixels, and the neighboring electrodes are located very close to each other. Therefore, the voltage is applied to the electrodes, and reactive power is consumed between neighboring pixels. The reactive power is generated by displacement current, and the displacement current is in proportion to an electric capacitance and to a variation in voltage with time. Therefore, if different voltage pulses are applied between the neighboring electrodes, the displacement current is generated due to the variation in voltage. In this regard, the electric capacity between the corresponding electrodes is in proportion to a dielectric constant and facing area of the electrodes, and is in inverse proportion to the distance between the electrodes. Therefore, if the electrodes are close to each other, the electric capacity increases, and thus, the displacement current and reactive power increase.

In the present embodiment (FIG. 2), since the first discharge electrodes 113 function as address electrodes and the second discharge electrodes 114 function as scan electrodes, voltages that are not the same as each other may be applied to the first discharge electrodes 113 or the second discharge electrodes 114. For example, an address voltage pulse may be applied to the first discharge electrodes 113 which are arranged in the sub-pixels intended to generate a certain address discharge operation, and the address voltage pulse may not be applied to the remaining first discharge electrodes 113. In addition, the scan pulse may be applied to the second discharge electrodes 114 which are arranged in typical sub-pixels intended to generate the address discharge, and may not be applied to the remaining second discharge electrodes 114. The variation in the voltage pulses applied to the first and second discharge electrodes 113 and 114, respectively, may become severe at a certain pattern, for example, a dot-on-off pattern. The disagreement between the voltage pulses applied to the first and second discharge electrodes 113 and 114, respectively, results in a displacement current, and increases the reactive power in the plasma display panel 100.

Therefore, it is desirable that the distance between the first discharge electrodes 113 and the distance between the second discharge electrodes 114 be increased in order to reduce the consumption of reactive power. However, if all of the first discharge electrodes 113 are separated from each other and all of the second discharge electrodes 114 are separated from each other, it is difficult to form fine pitch of the plasma display panel 100. If the distances between the first discharge electrodes 113 and the second discharge electrodes 114 increase, the number of unit pixels 150 is reduced, and the size of each discharge cell is reduced. Therefore, it may badly affect the resolution or the brightness of the plasma display panel 100. Thus, instead of reducing the distances between all of the first discharge electrodes 113 and all of the second discharge electrodes 114, distances d1 and k1 between the neighboring unit pixels becomes longer, and thus, the distance B1 between the first discharge electrodes 113 disposed on the different unit pixels from each other and the distance P1 between the second discharge electrodes 114 disposed on the different unit pixels from each other are increased, and the distances B2 and P2 between the first discharge electrodes 113 in the same unit pixel 150 and the second discharge electrodes 114 in the same unit pixel 150 can be shorter than the above distances B1 and P1. In the present embodiment, as described above, the width A1 of the longitudinal barrier rib portion defining the unit pixel 150 is larger than the width A2 of the longitudinal barrier rib portion disposed in the unit pixel 150, and the width E1 of the longitudinal barrier rib portion defining the unit pixel 150 is larger than the width E2 of the longitudinal barrier rib portion disposed in the unit pixel 150. Therefore, a desired arrangement of the unit pixels 150 can be realized. Then, the plasma display panel 100 can be formed as with fine pitch, and reactive power can be reduced. In particular, in the plasma display panel 100 including the above structure, the reduced amount of the plasma discharge generated due to the reduction in the transverse cross-section of the discharge cell 130 can be compensated by an increase of the discharge cell 130 in the depth direction (z direction).

Operations of the plasma display panel 100 according to the first embodiment of the present invention will be described as follows.

When the address voltage is applied between the first and second discharge electrodes 113 and 114, respectively, to generate an address discharge, the discharge cell 130 in which the sustain discharge occurs is selected as a result of the address discharge. After that, when a sustain voltage is applied between the first discharge electrode 113 and the second discharge electrode 114 in the selected discharge cell 130, wall charge accumulated on the first and second discharge electrodes 113 and 114, respectively, moves to generate the sustain discharge, and ultraviolet rays are emitted since the energy level of the discharge gas excited during the sustain discharge is reduced. In addition, the ultraviolet rays excite the phosphor layer 126 applied in the discharge cell 130, visible light is emitted by the reduced energy level of the excited phosphor layer 126, and the visible light transmits through the phosphor layer 126 and the front substrate 120 to form an image recognized by a user.

In the plasma display panel 5 of FIG. 1, the sustain discharge between the sustain electrodes 21 and 22 occurs in a horizontal direction, and the discharge area is relatively narrow. However, in the plasma display panel 100 of FIG. 2, according to the present invention, the sustain discharge occurs at every surface defining the discharge cell 130, and on the discharge area which is relatively large.

In addition, the sustain discharge occurs while forming a closed loop along the side surfaces of the discharge cell 130, and then spreading into the center portion of the discharge cell 130 gradually. Therefore, the volume of the region where the sustain discharge occurs can increase, and a space charge which was not conventionally used can distribute to the light emission. In addition, the luminous efficiency of the plasma display panel 100 can be improved.

Since the sustain discharge occurs only at the center portion of the discharge cell 130 in the plasma display panel 100 according to the present embodiment, ion sputtering of the phosphor layer due to the charged particles can be prevented, and thus a permanent residual image is not generated, even when the same image is displayed for a long period of time.

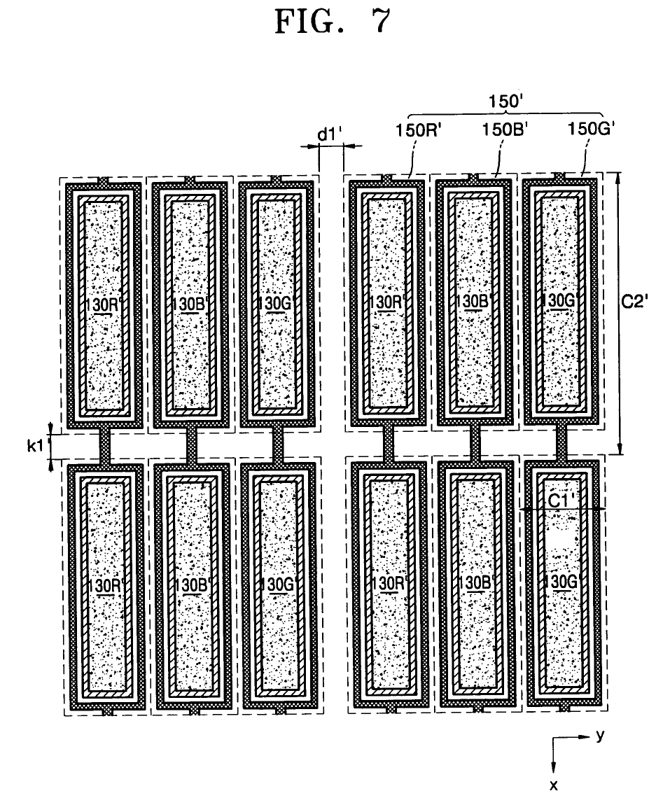

FIG. 7 is a schematic diagram of a modified version of the plasma display panel according to the first embodiment of the present invention, corresponding to the arrangement of FIG. 5.

FIG. 7 shows the arrangement of the red, green and blue discharge cells 130R′, 130G′ and 130B′, respectively, the red, green and blue sub-pixels 150R′, 150G′ and 150B′, respectively, and the unit pixel 150′ in a modified example of the plasma display panel according to the first embodiment. The difference between the modified example and the first embodiment is that the sub-pixels 150R′, 150G′ and 150B′ are formed as rectangular shapes. That is, transverse lengths C1′ of the sub-pixels 150R′, 150G′ and 150B′ are not the same as longitudinal lengths C2′, and in the present embodiment, the transverse lengths C1′ are shorter than the longitudinal lengths C2′. In addition, each unit pixel 150′ includes one red sub-pixel 150R′, one green sub-pixel 150G′, and one blue sub-pixel 150B′, and it is desirable that the unit pixel 150′ be formed as a regular square.

As in the first embodiment, since the adjacent unit pixels 150′ are arranged so as to be separated from each other by predetermined distances d1′ and k1′, reactive power can be reduced.

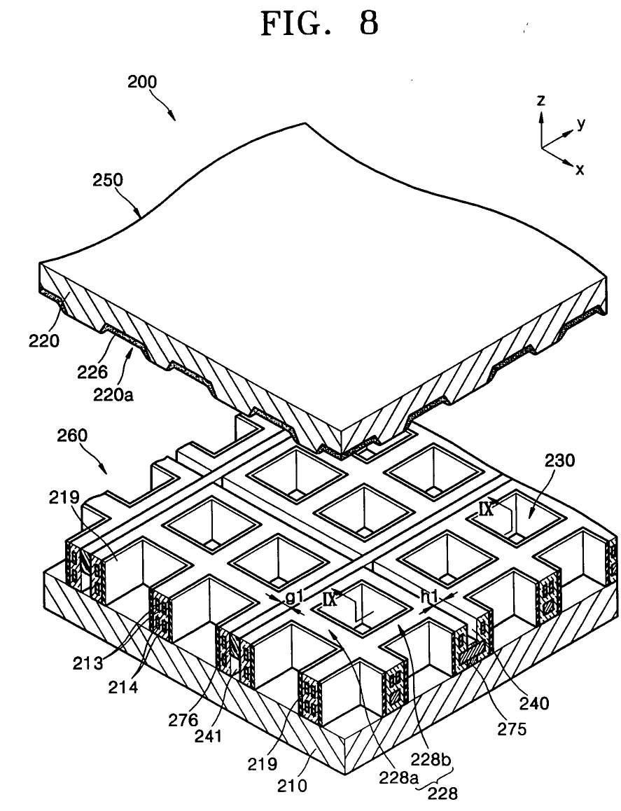

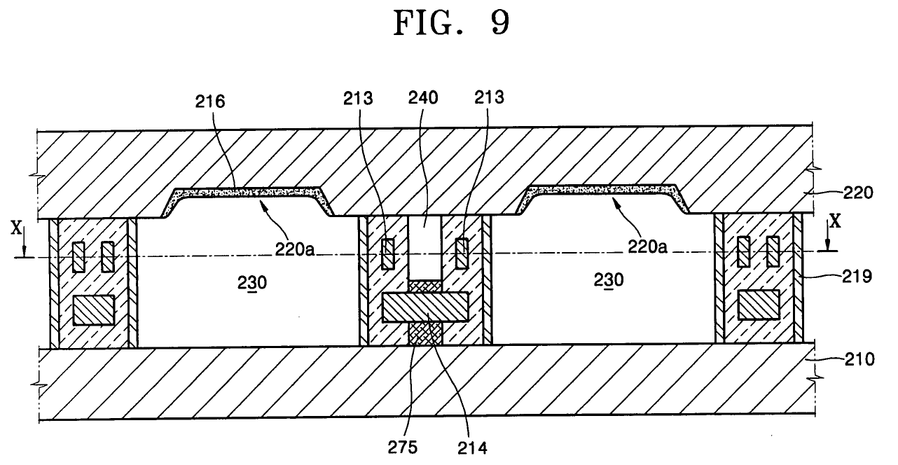

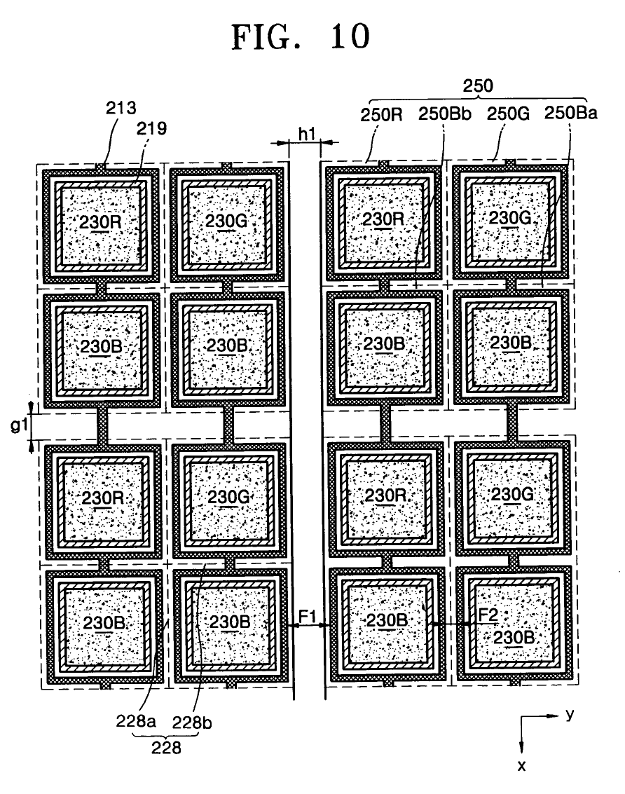

FIG. 8 is an exploded perspective view of a plasma display panel according to a second embodiment of the present invention; FIG. 9 is a cross-sectional view of the plasma display panel taken along line IX-IX of FIG. 8; and FIG. 10 is a schematic diagram of an arrangement of discharge cells, sub-pixels, and unit pixels taken along line X-X of FIG. 9.

Hereinafter, the plasma display panel 200 according to the second embodiment of the present invention will be described with reference to FIGS. 8 thru 10 based on the differences with the first embodiment. The plasma display panel 200 includes an upper panel 250 and a lower panel 260. The upper panel 250 includes a front substrate 220 and a phosphor layer 226, and the lower panel 260 includes a back substrate 210, barrier ribs 228, first discharge electrodes 213, and second discharge electrodes 214. The first and second discharge electrodes 213 and 214, respectively, extend so as to surround the discharge cells 260 which are arranged in rows. In the present embodiment, the first discharge electrodes 213 extend in a first direction (x direction), and the second discharge electrodes extend in a second direction (y direction). In addition, the barrier ribs 228 formed of the dielectric material include longitudinal barrier rib portions 228a arranged in a direction (x direction) in which the first discharge electrodes 213 extend, and transverse barrier rib portions 228b cross the longitudinal barrier rib portions 228a.

The difference between the present embodiment and the first embodiment is that spaces between the unit pixels 250 are not filled by the dielectric material, but form non-discharge areas 240 and 241. The difference will described in more detail as follows.

In the plasma display panel 200, the unit pixels 250 arranged in the direction (y direction) in which the second discharge electrodes 214 extend are separated by predetermined distances h1 from each other, as in the panel 100 of the first embodiment. To form the separations 240, the longitudinal barrier rib portions 228a, respectively defining the unit pixels 250 arranged in the direction of the second discharge electrodes 214 (y direction), are separated from each other with predetermined distances h1 therebetween, and the non-discharge region 240 is formed between the separated longitudinal barrier rib portions 228a. However, in the case wherein the second discharge electrodes 214 are exposed in the non-discharge region 240, the second discharge electrodes 214 may be damaged, and thus, it is desirable that the second discharge electrodes 214 exposed between the longitudinal barrier rib portion 228a be covered by a dielectric layer 275. As shown in FIGS. 8 and 9, the exposed second discharge electrodes 214 can be covered by an additional dielectric layer 275, or by a dielectric layer 275 integrally formed with the longitudinal barrier rib portions 228a. In order to form the dielectric layer 275 integrally with the longitudinal barrier rib portions 228a, it is desirable that a groove be formed on upper portions of the longitudinal barrier rib portions 128a of the plasma display panel 100 according to the first embodiment so as to form the non-discharge region 240 between the first discharge electrodes 213.

In addition, as in the first embodiment, the unit pixels 250 arranged in the direction (x direction) in which the first discharge electrodes 213 extend are separated by predetermined distances g1 from each other in the plasma display panel 200. To form the separated portion 241, the transverse barrier rib portions 228b respectively defining the unit pixels 250 which are arranged in the direction (x direction) in which the first discharge electrodes 213 extend are separated by predetermined distances g1 from each other, and the non-discharge region 241 is formed between the separated barrier rib portions 228b. However, in the case wherein the first discharge electrodes 213 are exposed in the non-discharge region 241, the first discharge electrodes 213 may be damaged, and thus, it is desirable that the first discharge electrodes 213 exposed between the transverse barrier rib portion 228b be covered by a dielectric layer 276.

When the non-discharge regions 240 and 241 are formed between the first discharge electrodes 213 and between the second discharge electrodes 214 disposed on the different unit pixels 250, the dielectric constants between the first discharge electrodes 213 and between the second discharge electrodes 214 can be reduced. In addition, the distance F1 between the first discharge electrodes 213, disposed at the different unit pixels 250 from each other, is longer than the distance F2 between the first discharge electrodes 213, disposed at the same unit pixel 250 as each other. Although not shown in the drawings, the distance between the second discharge electrodes 214 at the neighboring unit pixels is longer than the distance between the second discharge electrodes 214 disposed at the same unit pixel 250.

Therefore, the electric capacity between the first discharge electrodes 213 and between the second discharge electrodes 214 at the neighboring unit pixels 250 is reduced, and thus displacement current is reduced and reactive power is also reduced. In addition, the reduced reactive power due to the separation between the unit pixels 250 which are arranged in the directions in which the first and second discharge electrodes 213 and 214, respectively, extend is similar to that of the first embodiment, and detailed descriptions of that are omitted.

Elements such as the front substrate 220, on which the groove 220a is formed, a phosphor layer 216, a protective layer 219, the first discharge electrodes 213, the second discharge electrodes 214, the back substrate 210, and the discharge gas are similar to those of the plasma display panel 100 according to the first embodiment in view of structure and operation. In addition, referring to FIG. 10, red sub-pixels 250R, green sub-pixels 250G and blue sub-pixels 250Ba and 250Bb corresponding to red discharge cells 230R, green discharge cells 230G and blue discharge cells 230B, respectively, and the unit pixels 250 of regular square shape, including one red sub-pixel 250R, one green sub-pixel 250G, and two blue sub-pixels 250Ba and 250Bb, are also similar to those of the first embodiment. In addition, the operation of the plasma display panel 200 according to the second embodiment is similar to that of the plasma display panel 100 of the first embodiment, and thus, a detailed descriptions is omitted.

According to the present invention, a plasma display panel having improved luminous efficiency can be fabricated.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A plasma display panel, comprising:
a back substrate;
a front substrate separated from the back substrate so as to define a plurality of sub-pixels between the front and back substrates; and
first discharge electrodes and second discharge electrodes extending so as to cross each other for generating discharge in the sub-pixels,
wherein the sub-pixels form unit pixels, and the unit pixels adjacent to each other, at least in a direction, are separated by predetermined distances from each other.

2. The plasma display panel of claim 1, wherein the first discharge electrodes function as address electrodes, and the second discharge electrodes function as scan electrodes.

3. The plasma display panel of claim 2, wherein the unit pixels arranged in a direction in which the first discharge electrodes extend are separated by predetermined distances from each other.

4. The plasma display panel of claim 2, wherein the unit pixels arranged in a direction in which the second discharge electrodes extend are separated by predetermined distances from each other.

5. The plasma display panel of claim 1, wherein each unit pixel includes four sub-pixels.

6. The plasma display panel of claim 5, wherein said each unit pixel includes one red sub-pixel, one green sub-pixel, and two blue sub-pixels.

7. The plasma display panel of claim 5, wherein the sub-pixels are formed as regular square shapes.

8. The plasma display panel of claim 5, wherein said each unit pixel is formed as a regular square shape.

9. The plasma display panel of claim 1, wherein each unit pixel includes three sub-pixels.

10. The plasma display panel of claim 9, wherein the sub-pixels are formed as rectangular shapes.

11. The plasma display panel of claim 9, wherein the unit pixels are formed as regular square shapes.

12. The plasma display panel of claim 1, wherein separated portions between neighboring unit pixels form non-discharge regions.

13. The plasma display panel of claim 1, wherein at least a part of each separated portion between neighboring unit pixels is covered by a dielectric material.

14. A plasma display panel, comprising:
a back substrate;
a front substrate disposed so as to be separated from the back substrate;
barrier ribs disposed between the front and back substrates for defining, together with the back substrate and the front substrate, a plurality of discharge cells corresponding to sub-pixels;
first discharge electrodes surrounding the discharge cells;
second discharge electrodes separated by a predetermined distance from the first discharge electrodes so as to surround the discharge cells, and extending so as to cross a direction in which the first discharge electrodes extend;
phosphor layers disposed in the discharge cells; and
a discharge gas disposed in the discharge cells,
wherein the sub-pixels form unit pixels, and the unit pixels adjacent to each other, at least in a direction, are separated by predetermined distances from each other.

15. The plasma display panel of claim 14, wherein the first discharge electrodes function as address electrodes, and the second discharge electrodes function as scan electrodes.

16. The plasma display panel of claim 15, wherein the unit pixels arranged in a direction in which the first discharge electrodes extend are separated by predetermined distances from each other.

17. The plasma display panel of claim 15, wherein the unit pixels arranged in a direction in which the second discharge electrodes extend are separated by predetermined distances from each other.

18. The plasma display panel of claim 14, wherein barrier ribs defining two neighboring unit pixels are separated by a predetermined distance from each other so that a separated portion between the unit pixels forms a non-discharge region.

19. The plasma display panel of claim 14, wherein neighboring unit pixels are disposed so as to share at least one barrier rib, and a width of the barrier rib shared by the neighboring unit pixels is larger than widths of barrier ribs disposed in the unit pixels.

20. The plasma display panel of claim 14, wherein the barrier ribs include longitudinal barrier rib portions disposed in a direction in which the first discharge electrodes extend, and transverse barrier rib portion crossing the longitudinal barrier rib portions.

21. The plasma display panel of claim 20, wherein widths of the longitudinal barrier rib portions defining a unit pixel are larger than widths of the longitudinal barrier rib portions disposed in the unit pixel.

22. The plasma display panel of claim 20, wherein widths of the transverse barrier rib portions defining a unit pixel are larger than widths of the transverse barrier rib portions disposed in the unit pixel.

23. The plasma display panel of claim 14, wherein the each unit pixel includes four sub-pixels.

24. The plasma display panel of claim 23, wherein each unit pixel includes one red sub-pixel, one green sub-pixel, and two blue sub-pixels.

25. The plasma display panel of claim 23, wherein said sub-pixels are formed as regular square shapes.

26. The plasma display panel of claim 23, wherein said each unit pixel is formed as a regular square shape.

27. The plasma display panel of claim 14, wherein each unit pixel includes three sub-pixels.

28. The plasma display panel of claim 27, wherein the sub-pixels are formed as rectangular shapes.

29. The plasma display panel of claim 27, wherein said each unit pixel is formed as a regular square shape.

30. The plasma display panel of claim 14, wherein the first and second discharge electrodes are disposed inside the barrier ribs.

31. The plasma display panel of claim 14, wherein the phosphor layers are disposed between the front substrate and the first and second discharge electrodes.

32. The plasma display panel of claim 14, wherein grooves are formed on a back surface of the front substrate facing the discharge cells.

33. The plasma display panel of claim 32, wherein the phosphor layers are disposed in the grooves.

34. The plasma display panel of claim 32, wherein the grooves are formed discontinuously at the discharge cells.

35. The plasma display panel of claim 14, wherein the barrier ribs are formed of a dielectric material.

36. The plasma display panel of claim 14, further comprising a protective layer covering at least a part of side surfaces of the barrier ribs.
